(19) United States
(12) Patent Application Publication
(10) Pub. No.: US 2026/0023313 A1
(43) Pub. Date: Jan. 22, 2026

(54) LIGHT SOURCE AND PROJECTOR

(71) Applicant: SEIKO EPSON CORPORATION, Tokyo (JP)

(72) Inventor: Hiroaki MIYA, MATSUMOTO-SHI (JP)

(21) Appl. No.: 19/271,983

(22) Filed: Jul. 17, 2025

(30) Foreign Application Priority Data
Jul. 18, 2024 (JP) 2024-115070

(51) Int. Cl. G03B 21/20

(52) U.S. Cl. CPC G03B 21/208

(57) ABSTRACT

A light source according to the present disclosure includes a light source section that emits a light including a first beam, a light enlargement system that generates an enlarged light by enlarging the light along a first axis, a superimposing system that superimposes the enlarged light emitted from the light enlargement system on an illuminated region, and a light scanning section that scans with the enlarged light incident from the light enlargement system in a direction along a second axis orthogonal to the first axis in the illuminated region, wherein a cross section of the first beam along a plane orthogonal to an optical axis of the light enlargement system has a shape having a long side and a short side, and the short side of the first beam is along the first axis.

The present application is based on, and claims priority from JP Application Serial Number 2024-115070, filed Jul. 18, 2024, the disclosure of which is hereby incorporated by reference herein in its entirety.

### BACKGROUND

### 1. Technical Field

The present disclosure relates to a light source and a projector.

### 2. Related Art

As a light source used for a projector, a light source that illuminates a light modulation device such as a liquid crystal panel by temporally scanning the light modulation device with a light emitted from an optical element is proposed. JP-A-2007-225956 discloses a projector including a light source including a light source lamp, a liquid crystal light valve, a polygonal mirror disposed between the light source and the liquid crystal light valve, and a projection lens.

JP-A-2007-225956 is an example of the related art.

In the projector of JP-A-2007-225956, since the polygon mirror condenses the light emitted from the light source on the liquid crystal light valve while reflecting the light, there is a problem that the light density of the rectangular illumination light extending in the direction orthogonal to the scanning direction with respect to the liquid crystal light valve becomes high.

### SUMMARY

According to a first aspect of the present disclosure, there is provided a light source including a light source section that emits a light including a first beam, a light enlargement system that generates an enlarged light by enlarging the light along a first axis, a superimposing system that superimposes the enlarged light emitted from the light enlargement system on an illuminated region, and a light scanning section that scans with the enlarged light incident from the light enlargement system in a direction along a second axis orthogonal to the first axis in the illuminated region, wherein a cross section of the first beam along a plane orthogonal to an optical axis of the light enlargement system has a shape having a long side and a short side, and the short side of the first beam is along the first axis.

According to a second aspect of the present disclosure, there is provided a projector including the light source according to the first aspect, a light modulation device that modulates a light incident from the light source according to image information, and a projection optical device that projects the light modulated by the light modulation device.

### BRIEF DESCRIPTION OF THE DRAWINGS

FIG. 1 shows a schematic configuration of a projector of a first embodiment as seen from a +Y side.

FIG. 2 shows a schematic configuration of the projector of the first embodiment as seen from a +Z side.

FIG. 3 shows a relationship established between respective optical members in a plan view in a Y-axis direction.

FIG. 4 shows a cross-sectional shape of each color beam emitted from a light source section.

FIG. 5A shows a behavior of a blue beam when a transmissive optical element rotates.

FIG. 5B shows a behavior of the blue beam when the transmissive optical element rotates.

FIG. 5C shows a behavior of the blue beam when the transmissive optical element rotates.

FIG. 5D shows a behavior of the blue beam when the transmissive optical element rotates.

FIG. 5E shows a behavior of the blue beam when the transmissive optical element rotates.

FIG. 6 shows a behavior of a light transmitted through the transmissive optical element at color switching.

FIG. 7 shows a relationship established between the respective optical members in a plan view in a Z-axis direction.

FIG. 8 is a plan view showing a schematic configuration of a light enlargement system according to a first modification example as seen from the +Y side.

FIG. 9 is a perspective view showing a main part of a light source section of a second modification example.

FIG. 10 is a plan view of a projector of a second embodiment as seen from the +Y side.

FIG. 11 is a plan view of a projector of the second embodiment as seen from the +Z side.

### DESCRIPTION OF EMBODIMENTS

An embodiment of the present disclosure will be described below with reference to the drawings.

A projector of the embodiment is an example of a liquid crystal projector using a liquid crystal panel as a light modulation device.

In the following drawings, some component elements may be shown at different dimensional scales for clarity of the respective component elements. The following description with reference to the drawings will be made by using an XYZ orthogonal coordinate system as necessary. An X axis is an axis parallel to an illumination optical axis of a light source. The illumination optical axis is defined as an axis along a principal ray of an illumination light emitted from the light source. A Z axis is an axis orthogonal to the X axis and extends along a rotation axis O of a transmissive optical element 41. A Y axis is an axis orthogonal to the X axis and the Z axis. The Z axis of the embodiment corresponds to an example of “first axis” of the present disclosure, and the Y axis of the embodiment corresponds to an example of “second axis” of the present disclosure.

Hereinafter, for description of the configurations and arrangements of the respective members, one side (+X side) and the other side (−X side) in the direction along the X axis may be collectively referred to as “X-axis direction”, one side (+Y side) and the other side (−Y side) in the direction along the Y axis may be collectively referred to as “Y-axis direction”, and one side (+Z side) and the other side (−Z side) in the direction along the Z axis may be collectively referred to as “Z-axis direction”.

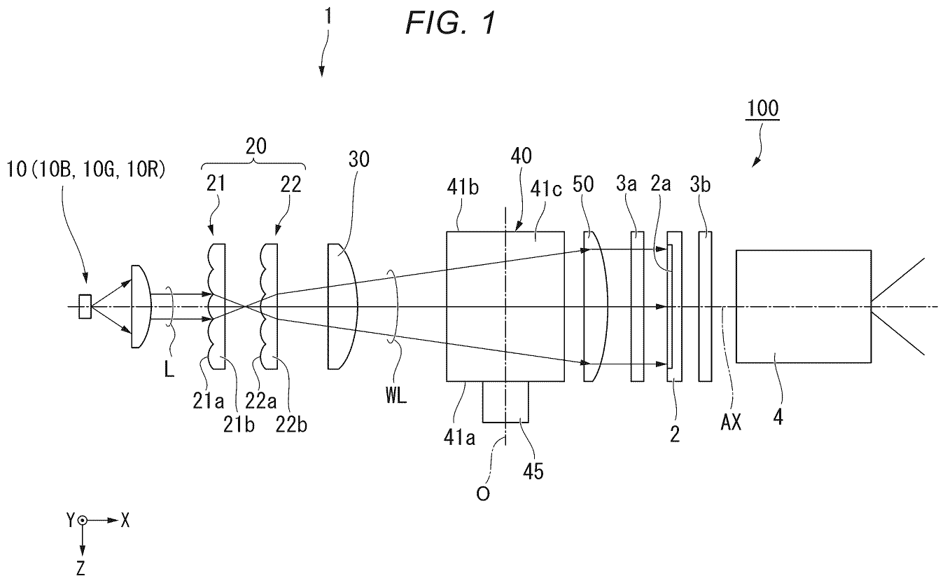

FIG. 1 is a plan view showing a schematic configuration of the projector of the embodiment as seen from the +Y side.

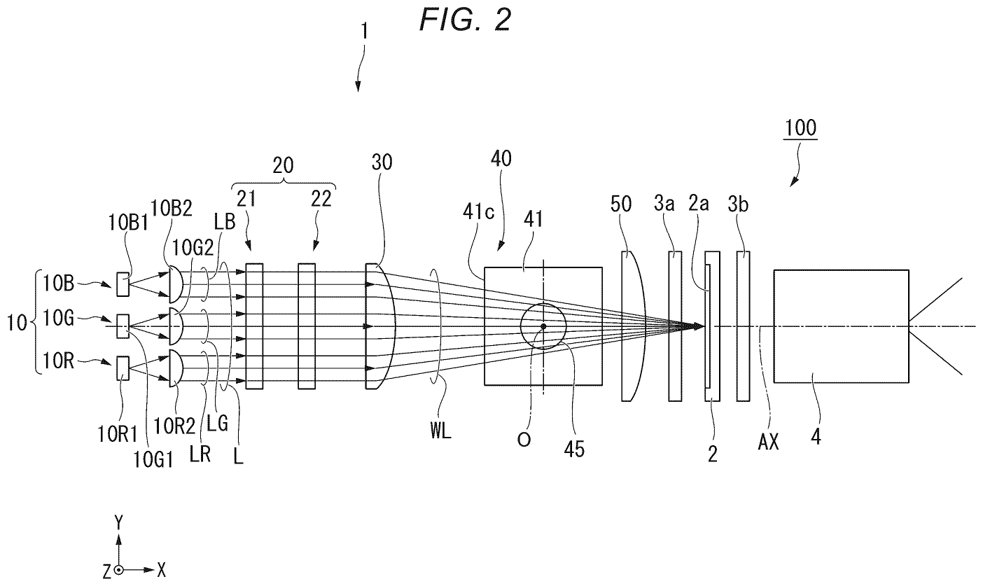

FIG. 2 is a plan view showing a schematic configuration of the projector of the embodiment as seen from the +Z side.

As shown in FIGS. 1 and 2, a projector 100 of the embodiment includes a light source 1, a light modulation device 2, a light incident-side polarizer 3a, a light exiting-side polarizer 3b, and a projection optical device 4.

The light source 1 includes a light source section 10, a light enlargement system 20, a superimposing system 30, a light scanning section 40, and a field lens 50.

The light source section 10 includes a blue light emitting unit 10B, a green light emitting unit 10G, and a red light emitting unit 10R. The light source section 10 causes the blue light emitting unit 10B, the green light emitting unit 10G, and the red light emitting unit 1CR to emit light at different times. In the light source section 10 of the embodiment, the blue light emitting unit 10B, the green light emitting unit 10G, and the red light emitting unit 1CR are formed in a single package structure. The blue light emitting unit 10B, the green light emitting unit 10G, and the red light emitting unit 1CR may have independent package structures.

The blue light emitting unit 10B includes a blue light emitting element 10B1 as a laser diode that emits a blue beam LB, and a collimator lens 10B2 that collimates the blue beam LB. The blue beam LB is, for example, a laser beam having a blue wavelength band of 450 nm±5 nm.

The green light emitting unit 10G includes a green light emitting element 10G1 as a laser diode that emits a green beam LG, and a collimator lens 10G2 that collimates the green beam LG. The green beam LG is, for example, a laser beam having a green wavelength band of 530 nm±5 nm.

The red light emitting unit 1CR includes a red light emitting element 10R1 of a laser diode that emits a red beam LR, and a collimator lens 10R2 that collimates the red beam LR. The red beam LR is, for example, a laser beam having a red wavelength band of 650 nm±5 nm.

The light emitting surfaces of the light emitting elements 10B1, 10G1, 10R1 of the light emitting units 10B, 10G, and 1CR are arranged on the same plane. In other words, the light source section 10 of the embodiment emits an illumination light L including the plurality of color beams LB, LG, and LR emitted from the light emitting points on the same plane.

In the embodiment, the blue beam LB corresponds to an example of “first beam” of the present disclosure, the green beam LG corresponds to an example of “second beam” of the present disclosure, and the red beam LR corresponds to an example of “third beam” of the present disclosure.

According to the configuration, the light source section 10 of the embodiment emits the illumination light L including the color beams LB, LG, and LR emitted in time sequence toward a light enlargement system 20. Therefore, the illumination light L emitted by the light source section 10 is a monochromatic light including any one of the color beams LB, LG, and LR. In the illumination light L emitted by the light source section 10, the blue beam LB, the green beam LG, and the red beam LR are aligned in the Y-axis direction. That is, the blue beam LB, the green beam LG, and the red beam LR are incident on the light enlargement system 20 through different optical paths.

The light enlargement system 20 enlarges the illumination light L emitted from the light source section 10 along the Z-axis direction to generate an enlarged illumination light WL having a rectangular shape extending along the Z axis. The enlarged illumination light WL in the embodiment corresponds to an example of “enlarged light” in the present disclosure.

The light enlargement system 20 of the embodiment includes a first lenticular lens 21 and a second lenticular lens 22. In the embodiment, since the first lenticular lens 21 and the second lenticular lens 22 are separate lenses, it is easy to manufacture the lenses.

The first lenticular lens 21 and the second lenticular lens 22 have the same shape. Therefore, the lens pitches of the first lenticular lens 21 and the second lenticular lens 22 are equal.

The first lenticular lens 21 includes a first base material 21b that is a flat plate-shaped light-transmissive substrate, and a plurality of first lenses 21a provided on the first base material 21b. The plurality of first lenses 21a are provided on the first base material 21b so as to be arranged in the Z-axis direction. Each first lens 21a is a cylindrical convex lens having positive power in the Z-axis direction and no power in the Y-axis direction. Therefore, each first lens 21a divides the illumination light L incident from the light source section 10 into a plurality of pencils of light in the Z-axis direction. Each pencil of light is diffused in the Z-axis direction in which the first lens has power.

The second lenticular lens 22 includes a second base material 22b that is a flat plate-shaped light-transmissive substrate, and a plurality of second lenses 22a provided on the second base material 22b. The plurality of second lenses 22a are provided on the second base member 22b so as to be arranged in the Z-axis direction. The plurality of second lenses 22a respectively correspond to the plurality of first lenses 21a of the first lenticular lens 21. Each second lens 22a is a cylindrical convex lens having positive power in the Z-axis direction and no power in the Y-axis direction.

The second lenticular lens 22 forms an image of each of the first lenses 21a of the first lenticular lens 21 on an image formation region 2a of a light modulation device 2, which is an illuminated region, or the vicinity thereof together with a superimposing system 30 in the subsequent stage in the Z-axis direction in which the second lens has power.

The first lenticular lens 21 and the second lenticular lens 22 transmit the illumination light L incident from the light source section 10 without changing the traveling direction in the Y-axis direction in which the lenses have no power. The illumination light L transmitted through the first lenticular lens 21 and the second lenticular lens 22 in the Y-axis direction is condensed by the superimposing system 30 to the image formation region 2a of the light modulation device 2 or the vicinity thereof.

In this manner, the light enlargement system 20 of the embodiment diffuses the illumination light L emitted from the light source section 10 in the Z-axis direction to generate an enlarged illumination light WL having a rectangular shape extending in the Z-axis direction.

The rate of change (degree of diffusion) of the luminous flux width in the Z-axis direction in the light enlargement system 20 can be adjusted, for example, by adjusting optical characteristics such as curvature and refractive index of each lens forming the first lenticular lens 21 and the second lenticular lens 22.

The light scanning section 40 scans the illuminated region with the enlarged illumination light WL incident from the light enlargement system 20 in the Y-axis direction. Specifically, the light scanning section 40 scans with the band-shaped enlarged illumination light WL extending in the Z-axis direction in the image formation region 2a of the light modulation device 2 disposed in the illuminated region in the Y-axis direction. Therefore, the light scanning section 40 can efficiently illuminate the entire image formation region 2a by scanning with the band-shaped enlarged illumination light WL in the short-side direction thereof. Since the enlarged illumination lights WL are superimposed on each other in the Y-axis direction, the uniformity of the intensity distribution in the image formation region 2a can be enhanced.

In the embodiment, a field lens 50 is provided between the light scanning section 40 and the light modulation device 2. The field lens 50 deflects the enlarged illumination light WL incident from the light scanning section 40. Thus, the light scanning section 40 can efficiently illuminate the image formation region 2a of the light modulation device 2 with the enlarged illumination light WL.

In the embodiment, the light scanning section 40 scans with the enlarged illumination light WL incident from the superimposing system 30 in the Y-axis direction on the image formation region 2a of the light modulation device 2.

The light scanning section 40 includes a transmissive optical element 41 and a rotational drive unit 45.

The transmissive optical element 41 is formed of a light-transmissive member that is rotatably supported. The transmissive optical element 41 is rotatable around the rotation axis O extending along the Z-axis direction. The transmissive optical element 41 is coupled to the rotational drive unit 45 including a motor or the like. The transmissive optical element 41 rotates around the rotation axis O by driving of the rotational drive unit 45.

As the glass material of the light-transmissive member forming the transmissive optical element 41, for example, a light-transmissive material such as optical glass including BK7, quartz, or resin. The transmissive optical element 41 of the embodiment has a front surface 41a and a back surface 41b that intersect the rotation axis O, and four side surfaces 41c in perpendicular contact with the front surface 41a and the back surface 41b. That is, the shape of the transmissive optical element 41 is a regular quadrangular prism having six flat surfaces including the front surface 41a, the back surface 41b, and the four side surfaces 41c. A cross-sectional shape of the transmissive optical element 41 cut along a plane perpendicular to the rotation axis O is a square shape. That is, the four side surfaces 41c have the same area, and the two side surfaces facing each other are parallel to each other. The rotation axis O coincides with the center of the square transmissive optical element 41.

The transmissive optical element 41 transmits the enlarged illumination light WL emitted from the light enlargement system 20 while rotating around the rotation axis O. Therefore, the side surface from which the enlarged illumination light WL emitted from the light enlargement system 20 is incident on the transmissive optical element 41 is not uniquely fixed, but changes with time. Similarly, the side surface from which the enlarged illumination light WL incident on the transmissive optical element 41 is emitted to the external space is not uniquely fixed, but changes with time. In the transmissive optical element 41, the side surface from which the enlarged illumination light WL emitted from the light enlargement system 20 is incident is referred to as “incident surface”. The side surface from which the enlarged illumination light WL incident from the incident surface is emitted is referred to as “exit surface” In this case, the incident surface and the exit surface change with time, and are any two side surfaces parallel to each other of the four second side surfaces 41c.

In the specification, the case where two surfaces of the transmissive optical element 41 are parallel to each other refers to a case where two surfaces forming an angle ω ithin a range of 0±5 degrees are “parallel” in consideration of processing accuracy of a glass material forming the light-transmissive member, an allowable range of the parallelism of the light, and the like.

In the case of the embodiment, the transmissive optical element 41 has the four side surfaces 41c. The number of side surfaces is not necessarily four, but is desirably 2×m (m is a natural number of 2 or more). That is, the number of side surfaces is desirably an even number such as six or eight. When the number of side surfaces is the even number, all side surfaces are parallel to the opposing side surfaces and there are no non-parallel side surfaces. Thus, a stray light is rarely generated in the transmissive optical element 41, and the light use efficiency can be increased.

The light modulation device 2 is provided at the light exiting side of the light scanning section 40 on an illumination optical axis AX. The light modulation device 2 modulates the enlarged illumination light WL emitted from the light scanning section 40 according to image information to form an image light. A transmissive liquid crystal panel is used as the light modulation device 2. Examples of a method for driving the liquid crystal panel include, but not particularly limited to, a twisted nematic (TN) method, a vertical alignment (VA) method, and an in-plane switching (IPS) method.

Here, it is desirable that the size in the Z-axis direction of the enlarged illumination light WL that illuminates the image formation region 2a of the light modulation device 2 is set to be slightly larger than the size of the image formation region 2a of the light modulation device 2. The present discloser has found that it is desirable to expand the size of the enlarged illumination light WL outward by 0.5 mm or more based on a simulation.

FIG. 3 shows a relationship established between the optical members in a plan view in the Y-axis direction. In FIG. 3, the light scanning section 40, the field lens 50, and the light-incident side polarizer 3a, which are not used in the description, are omitted for clarity.

In FIG. 3, the lens pitch of the first lenticular lens 21 and the second lenticular lens 22 is a, the luminous flux width of the enlarged illumination light WL in the Z-axis direction is a1, the lens-to-lens distance between the first lenticular lens 21 and the second lenticular lens 22 is b, and the distance between the superimposing system 30 and the light modulation device 2 is b1.

The light emitted from the first lens 21a of the first lenticular lens 21 is parallelized by the second lens 22a of the second lenticular lens 22, and an image is formed on the image formation region 2a of the light modulation device 2 by the superimposing system 30. Accordingly, among the lens pitch a, the luminous flux width a1, the lens-to-lens distance b, and the distance b1, a relationship of a: a1=b:b1 is established. Therefore, the luminous flux width a1 is defined by a1=a×b1/b.

As described above, a margin of 1.0 mm or more is desirably considered for the luminous flux width in the Z-axis direction in the enlarged illumination light WL on both sides. Therefore, in consideration of the margin of the enlarged illumination light WL, a dimension S of the image formation region 2a in the Z-axis direction satisfies a relationship of the following expression (1).

$$S < ( a \times b 1 / b ) - 1. \qquad Expression ( 1 )$$

When Expression (1) is satisfied, the enlarged illumination light WL can favorably illuminate the image formation region 2a of the light modulation device 2 even when the attachment of the optical components varies or the precision of the lenticular lens is poor.

Here, as shown in FIG. 1, in the enlarged illumination light WL, a plurality of diffused luminous fluxes divided in the Z-axis direction are superimposed. Therefore, the light density of the enlarged illumination light WL in the Z-axis direction has higher uniformity.

In contrast, as shown in FIG. 2, the enlarged illumination light WL condensed in the Y-axis direction is incident on the image formation region 2a of the light modulation device 2. Accordingly, the light density of the enlarged illumination light WL in the Y-axis direction tends to be higher. When the light density is too high, the image formation region 2a of the light modulation device 2 and the light incident-side polarizer 3a, which will be described later, may be damaged by heat, and thereby reducing the reliability.

The present discloser has studied a configuration in which the light density of the enlarged illumination light WL in the Y-axis direction is suppressed to be lower, and has found that the light density on the illuminated region varies depending on the relationship between the directions of the respective color beams LB, LG, and LR respectively emitted from the light emitting units 10B, 10G, and 1CR of the light source 10 and the enlargement direction (Z-axis direction) of the illumination light L by the light enlargement system 20. Then, the present discloser completed the light source 1 of the embodiment.

Subsequently, the cross-sectional shapes of the color beams LB, LG, and LR emitted from the light source section 10 will be described.

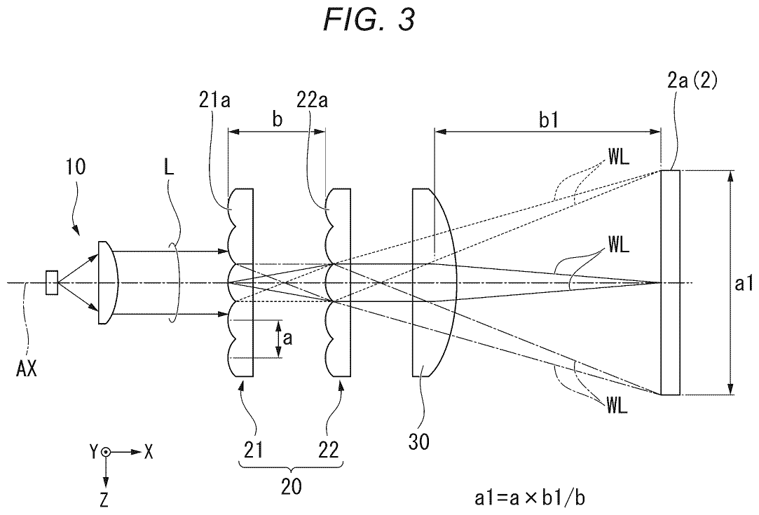

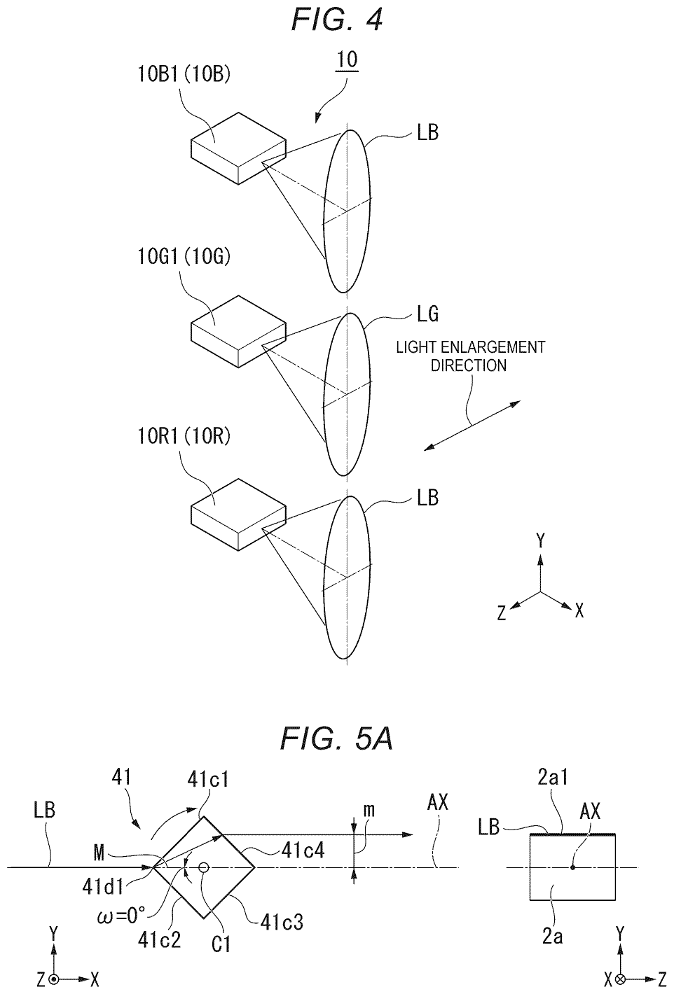

FIG. 4 shows the cross-sectional shapes of the color beams LB, LG, and LR emitted from the light source section 10. FIG. 4 shows the cross-sectional shapes cut along a plane perpendicular to the principal rays of the color beams LB, LG, and LR. The principal rays of the color beams LB, LG, and LR are parallel to the illumination optical axis AX.

As shown in FIG. 4, in the light source section 10 of the embodiment, the light emitting surfaces of the light emitting elements 10B1, 10G1, 10R1 of the light emitting units 10B, 10G, and 1CR have rectangular shapes. For example, the cross section of the blue beam LB emitted from the blue light emitting element 10B1 has an elliptical shape having a long side (long axis) along the short-side direction of the rectangular light emitting surface and a short side (short axis) along the long-side direction of the rectangular light emitting surface. The cross sections of the green beam LG emitted from the green light emitting element 10G1 and the red beam LR emitted from the red light emitting element 10R1 have the same elliptical shape as the blue beam LB.

The short sides of the blue beam LB, the green beam LG, and the red beam LR are along the Z-axis direction. The long sides of the blue beam LB, the green beam LG, and the red beam LR are along the Y-axis direction. The blue beam LB, the green beam LG, and the red beam LR are arranged side by side in the Y-axis direction.

In the light source 1 of the embodiment, the light enlargement direction (Z-axis direction) of the enlarged illumination light WL by the light enlargement system 20 coincides with the short-side directions of each of the color beams LB, LG, and LR emitted as the illumination light L from the light source section 10 and is incident on the light enlargement system 20. That is, the light enlargement system 20 does not diffuse the color beams LB, LG, and LR in the long-side direction, but diffuses the color beams LB, LG, and LR in the short-side direction, and thereby generating the enlarged illumination light WL.

According to the configuration, as compared with the case where the color beams LB, LG, and LR are enlarged in the long-side direction, the light density of the enlarged illumination light WL can be suppressed to be lower by diffusing the color beams LB, LG, and LR in the short-side direction.

Here, the ratio of the length in the short-side direction to the length in the long-side direction of the cross section of each of the color beams LB, LG, and LR is referred to as an aspect ratio. That is, a beam having a larger aspect ratio has a more elongated shape as compared with a beam having a smaller aspect ratio.

In the light source 1 of the embodiment, the long-side direction of the aspect ratio of the cross section of the illumination light L emitted from the light source section 10 is the Y-axis direction as shown in FIG. 4. Here, the aspect ratio of the cross section of the illumination light L corresponds to the aspect ratio of the cross section of each of the color beams LB, LG, and LR when the color beams LB, LG, and LR are emitted in time sequence as in the light source section 10 of the embodiment. When the light source section 10 emits pluralities of (for example, twos of) color beams LB, LG, and LR, a region including twos of the color beams LB, LG, and LR corresponds to the cross section of the illumination light L, and the aspect ratio of the region corresponds to the aspect ratio of the illumination light L.

On the other hand, as shown in FIGS. 1 and 2, the long-side direction of the aspect ratio of the cross section of the enlarged illumination light WL emitted from the light enlargement system 20 is the Z-axis direction. That is, in the embodiment, the light enlargement system 20 can enlarge the respective color beams LB, LG, and LR having the long sides in the Y-axis direction in the Z-axis direction, and can favorably generate the enlarged illumination light WL having the long sides in the Z-axis direction.

The present discloser has found that, the more elongated the shapes of the color beams LB, LG, and LR emitted from the light source section 10, the greater the effect of matching the light enlargement direction of the enlarged illumination light WL with the short-side direction of the color beams LB, LG, and LR. Therefore, in the light source 1 of the embodiment, the aspect ratio of each of the blue beam LB, the green beam LG, and the red beam LR is three times or more. By using the light source section 10 that emits the illumination light L including the beam having the aspect ratio at three times or more as described above, the effect of suppressing the light density of the enlarged illumination light WL can be further enhanced.

The light incident-side polarizer 3a is disposed at the light incident side of the light modulation device 2 on the illumination optical axis AX. The light exiting-side polarizer 3b is disposed at the light exiting side of the light modulation device 2 on the illumination optical axis AX. The transmission axes of the light incident-side polarizer 3a and the light exiting-side polarizer 3b are orthogonal to each other.

The light incident-side polarizer 3a transmits a linearly polarized component in a specific direction of the enlarged illumination light WL emitted from the light source section 10 toward the light modulation device 2. The light exiting-side polarizer 3b transmits a linearly polarized light emitted from the light modulation device 2 in a specific direction toward the projection optical device 4. In the case of the embodiment, since the light source section 10 uses a laser emitting element, the illumination light L incident from the light source section 10 is a linearly polarized light. However, in the transmissive optical element 41, the amount of light absorbed by the light transmissive member increases as the amount of light transmitted through the light transmissive member increases, and thermal strain may be generated in the light transmissive member. In this case, the polarization direction of the illumination light WL emitted from the light source section 10 is disturbed, and the linearly polarized light incident on the light transmissive member is converted into elliptically polarized light and is then emitted from the light transmissive member. In the case of the embodiment, by providing the light incident-side polarizer 3a, even when the polarization direction of the illumination light L is disturbed, the linearly polarized component in the specific direction can be incident on the light modulation device 2.

When quartz, which is a glass material having a small Young's modulus and a small thermal expansion coefficient, is used as the transmissive optical element 41, the polarization direction is less likely to be disturbed, and thus the light incident-side polarizer 3a provided at the light incident side of the light modulation device 2 can be omitted.

The projection optical device 4 includes a plurality of projection lenses. The projection optical device 4 enlarges and projects the image light modulated by the light modulation device 2 toward a projected surface such as a screen. Thus, an image is displayed on the projected surface.

Behaviors of the enlarged illumination light WL transmitted through the transmissive optical element 41 will be described in detail. Since the behaviors of the color beams LB, LG, and LR contained in the enlarged illumination light WL are the same, the behavior of the blue beam LB and the behavior at switching from the blue beam LB to the green beam LG will be described below.

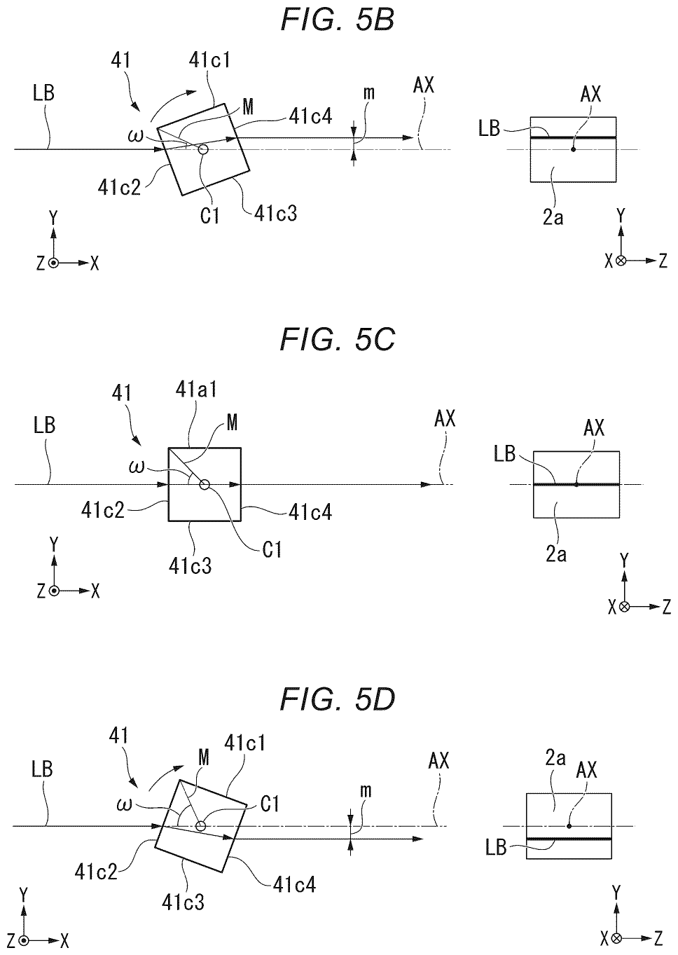

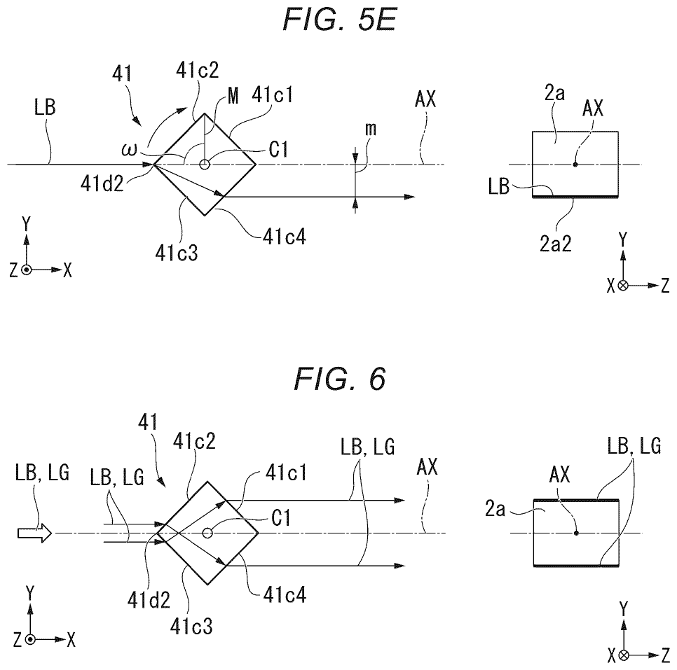

FIGS. 5A to 5E are schematic diagrams showing the behaviors of the blue beam LB when the transmissive optical element 41 rotates. In this example, the transmissive optical element 41 rotates clockwise around the rotation axis O as seen from the +Z side, and the time elapses from FIG. 5A toward the state shown in FIG. 5E. In FIGS. 5A to 5E, illustration of the rotational drive unit 45 is omitted.

In FIGS. 5A to 5E, an angle formed by the illumination optical axis AX and a straight line M connecting a top portion 41d1 as an intersection of a side surface 41c1 and a side surface 41c2 and the rotation axis O is defined as a rotation angle ω of the transmissive optical element 41. Actually, the blue beam LB has a predetermined luminous flux width in the Z-axis direction, however, here, the behavior of the principal ray traveling on the illumination optical axis AX is focused on.

In FIGS. 5A to 5E, amounts of displacement m from the illumination optical axis AX of the principal ray of the blue beam LB are shown on the left sides, and states in which the blue beam LB scans the image formation region 2a as the illuminated region are shown on the right sides.

FIG. 5A shows an initial state in which the blue beam LB is incident on the transmissive optical element 41. In the state illustrated in FIG. 5A, the straight line M and the illumination optical axis AX overlap each other, and the rotation angle ω is 0 degrees. Here, the blue beam LB is incident on the end portion at the +Y side of the side surface 41c2 at an incident angle (45 degrees). The blue beam LB is refracted in the direction (+Y side) shown in the drawing and travels inside the transmissive optical element 41. Then, the blue beam LB is also incident on a side surface 41c4 at the same incident angle as the side surface 41c2, and thus the blue beam is refracted by the side surface 41c4 and is emitted from the transmissive optical element 41. Here, since the side surface 41c2 and the side surface 41c4 are parallel to each other, the incident angle of the blue beam LB with respect to the side surface 41c2 and the incident angle of the blue beam LB with respect to the side surface 41c4 are equal, and the refraction angle of the blue beam LB incident on the side surface 41c2 and the refraction angle of the blue beam LB emitted from the side surface 41c4 have opposite signs and have equal absolute values. Accordingly, the refraction angle of the blue beam LB at the time of being incident on the side surface 41c2 and the refraction angle at the time of being emitted from the side surface 41c4 cancel each other. As a result, the blue beam LB travels parallel to the illumination optical axis AX at a position displaced from the illumination optical axis AX to the +Y side by the amount of displacement m.

Accordingly, the blue beam LB emitted from the transmissive optical element 41 is incident on an end portion 2a1 at the +Y side of the image formation region 2a of the light modulation device 2 as the illuminated region.

Then, as illustrated in FIG. 5B, when the rotation angle ω of the transmissive optical element 41 becomes larger than that in FIG. 5A, the incident angle of the blue beam LB becomes smaller and the refraction angle also becomes smaller. Therefore, the amount of displacement m of the blue beam LB from the illumination optical axis AX is smaller than that in FIG. 5A. The state in which the blue beam LB travels in parallel to the illumination optical axis AX is constantly maintained. While the rotation angle ω is from 0 degrees to 45 degrees, the amount of displacement m monotonously decreases with the increase of the rotation angle ω.

Thus, the blue beam LB emitted from the transmissive optical element 41 is incident on the position closer to the −Y side of the image formation region 2a of the light modulation device 2 than that in FIG. 5A.

Then, as illustrated in FIG. 5C, when the rotation angle ω of the transmissive optical element 41 becomes 45 degrees, which is larger than that in FIG. 5B, the straight line M and the illumination optical axis AX overlap each other, and the blue beam LB is incident perpendicularly onto the side surface 41c2. That is, the incident angle of the blue beam LB with respect to the side surface 41c2 is 0 degrees. Therefore, since the blue beam LB is incident perpendicularly onto the side surface 41c2, the blue beam LB travels inside the transmissive optical element 41 along the illumination optical axis AX without being refracted by the side surface 41c2. Then, the blue beam LB is also incident perpendicularly onto the side surface 41c4 parallel to the side surface 41c2. Therefore, the blue beam LB is emitted from the transmissive optical element 41 without being refracted by the side surface 41c4, and travels on the illumination optical axis AX. Here, the blue beam LB emitted from the transmissive optical element 41 is incident on the center part of the image formation region 2a of the light modulation device 2 in the Y-axis direction.

Then, as illustrated in FIG. 5D, when the rotation angle ω of the transmissive optical element 41 exceeds 45 degrees, the incident position of the blue beam LB changes to the position closer to the side surface 41c3 side than the center of the side surface 41c2. Here, the blue beam LB is refracted by the side surface 41c2 in the refraction direction, the direction (−Y side) illustrated in the drawing, different from that in the period up to FIG. 5B. The relationship in which the refraction angle of the blue beam LB at the time of being incident on the side surface 41c2 and the refraction angle of the blue beam LB at the time of being emitted from the side surface 41c4 cancel each other is the same as that in the period up to FIG. 5B. As a result, the blue beam LB travels parallel to the illumination optical axis AX at a position displaced from the illumination optical axis AX to the −Y side by the amount of displacement m. While the rotation angle ω is from 45 degrees to 90 degrees, the amount of displacement m monotonously increases with the increase of the rotation angle ω.

Accordingly, the blue beam LB emitted from the transmissive optical element 41 is incident on the position closer to the −Y side than the center part of the image formation region 2a of the light modulation device 2.

Then, as illustrated in FIG. 5E, the rotation angle ω of the transmissive optical element 41 becomes maximum, and the amount of displacement m becomes maximum while the state in which the blue beam LB travels parallel to the illumination optical axis AX is maintained.

Accordingly, the blue beam LB emitted from the transmissive optical element 41 is incident on an end portion 2a2 at the −Y side of the image formation region 2a of the light modulation device 2, which is the illuminated region.

As described above, the blue beam LB incident on the side surface 41c2 of the rotating transmissive optical element 41 can scan the image formation region 2a of the light modulation device 2 in the Y-axis direction.

In the state illustrated in FIG. 5E, the top portion 41d2 of the transmissive optical element 41 located at the boundary between the side surface 41c2 and the side surface 41c3 overlaps the illumination optical axis AX. In the case of the embodiment, at the time shown in FIG. 5E, the light source section 10 switches the emitted illumination light L from the blue beam LB to the green beam LG.

FIG. 6 shows the behavior of the light transmitted through the transmissive optical element 41 when the blue beam LB is switched to the green beam LG.

As shown in FIG. 6, at the time when the top portion 41d2 of the transmissive optical element 41 overlaps the illumination optical axis AX, the blue beam LB or the green beam LG is incident on both the side surface 41c2 and the side surface 41c3 of the transmissive optical element 41, and is respectively emitted from the side surface 41c4 and the side surface 41c1. That is, when switched from the blue beam LB to the green beam LG, the blue beam LB and the green beam LG emitted from the transmissive optical element 41 are separated into two in the Y-axis direction. For example, when the blue beam LB and the green beam LG are respectively incident on both ends of the image formation region 2a in the Y-axis direction, different color lights are incident on the same region (both ends in the Y-axis direction) of the image formation region 2a in time sequence, and the quality of a projected image is deteriorated due to color mixture.

In contrast, in the projector 100 of the embodiment, the size of the image formation region 2a is set such that, when the enlarged illumination light WL is transmitted through the transmissive optical element 41 and separated into two beams in the Y-axis direction, the two separated beams are incident on the outside of the image formation region 2a. As a result, the occurrence of color mixture can be suppressed.

However, as the luminous flux width in the Y-axis direction of the illumination light L emitted from the light source section 10 is increased, the time for separation of the illumination light L into two increases, the time for the illumination light L emitted from the light source section 10 are not incident on the image formation region 2a increases, and a problem that the use efficiency of the illumination light L emitted from the light source section 10 decreases arises.

The present discloser considered that when the luminous flux width of the illumination light L is too narrow, the image formation region 2a is locally heated, and on the contrary, when the luminous flux width of the illumination light L is too wide, the use efficiency of the illumination light L in the image formation region 2a decreases as described above, and thus it is desirable to set the luminous flux width of the illumination light L to be half or less of the image formation region 2a.

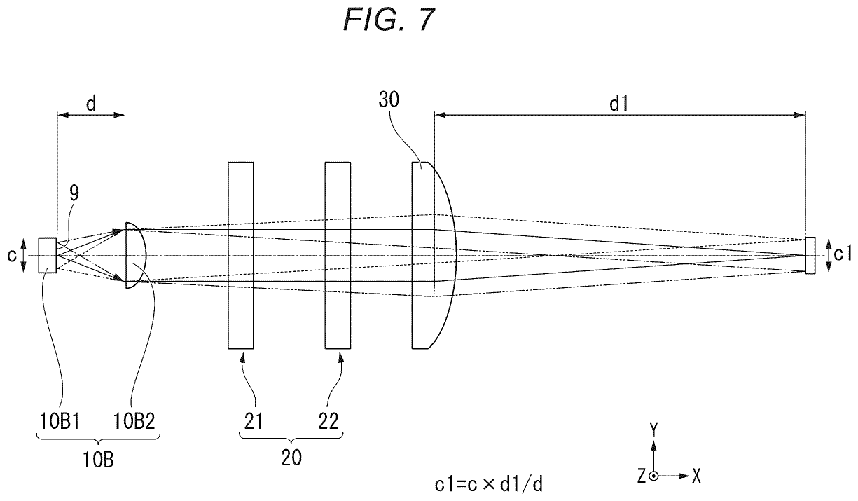

FIG. 7 shows a relationship established between the optical members in a plan view in the Z-axis direction. In FIG. 7, the light scanning section 40, the field lens 50, and the light incident-side polarizer 3a, which are not used in the description, are omitted for clarity. In FIG. 7, the blue light emitting unit 10B of the light source section 10 is illustrated.

In FIG. 7, the dimension in the Y-axis direction in a light emitting region 9 of the light emitting element 10B1 of the blue light emitting unit 10B is c, the luminous flux width in the Y-axis direction of the enlarged illumination light WL is c1, the focal length of the collimator lens 10B2 of the blue light emitting unit 10B is d, and the distance between the superimposing system 30 and the light modulation device 2 is d1.

The blue beam LB emitted from the light emitting region 9 of the light emitting element 10B1 is collimated by the collimator lens 10B2. Since the first lenticular lens 21 and the second lenticular lens 22 do not have lens power in the Y-axis direction, the blue beam LB collimated by the collimator lens 10B2 passes through the first lenticular lens 21 and the second lenticular lens 22. Then, the blue beam LB is imaged on the image formation region 2a of the light modulation device 2 by the superimposing system 30. Accordingly, the dimension c, the luminous flux width c1, the focal length d, and the distance d1 of the light emitting region 9 satisfy the relationship of c:c1=d: d1. Therefore, the luminous flux width c1 is defined by c1=c×d1/d.

As described above, it is desirable that the luminous flux width in the Y-axis direction in the enlarged illumination light WL is equal to or less than half of the image formation region 2a in consideration of heat generation and a decrease in light use efficiency. Therefore, in the projector 100 of the embodiment, the dimension S1 of the image formation region 2a in the Y-axis direction satisfies the relationship of the following expression (2).

$$S 1 > 2 \times c \times d 1 / d \qquad Expression ( 2 )$$

When Expression (2) is satisfied, the light of the light source can be efficiently incident on the image formation region with suppressed heat generation in the image formation region.

As described above, the light source 1 of the embodiment includes the light source section 10 that emits the illumination light L including the blue beam LB, the green beam LG, and the red beam LR, the light enlargement system 20 that generates the enlarged illumination light WL by enlarging the illumination light L in the Z-axis direction, and the light scanning section 40 that scans the image formation region 2a of the light modulation device 2 as the illuminated region in the Y-axis direction with the enlarged illumination light WL incident from the light enlargement system 20. The cross section along the YZ-plane perpendicular to the principal ray of the blue beam LB has the elliptical shape having the long side and the short side, and the short side of the blue beam LB at incidence on the light enlargement system 20 is along the Z axis.

According to the light source 1 of the embodiment, the light enlargement system 20 can convert the illumination light L emitted from the light source section 10 into the enlarged illumination light WL having the rectangular shape elongated in the Z-axis direction. In the case of the embodiment, since the light enlargement system 20 diffuses the color beams LB, LG, and LR in the short-side direction to generate the enlarged illumination light WL, the light density of the enlarged illumination light WL can be suppressed to be lower. Therefore, the light scanning section 40 can illuminate the entire image formation region 2a of the light modulation device 2 while suppressing the damage due to the heat in the light incident-side polarizer 3a and the light modulation device 2.

According to the projector 100 of the embodiment, since the enlarged illumination light WL emitted from the light source 1 is scanned on the image formation region 2a of the light modulation device 2, a brighter image can be projected. Further, since the light density of the enlarged illumination light WL is suppressed, the damage due to the heat in the light modulation device 2 is suppressed, and the reliability of the projector 100 can be further enhanced.

### First Modification Example

A first modification example of the above described embodiment will be described.

The modification example is different from the above described embodiment in the configuration of the light enlargement system. The members in common with the above described embodiment have the same signs and the detailed description thereof will be omitted.

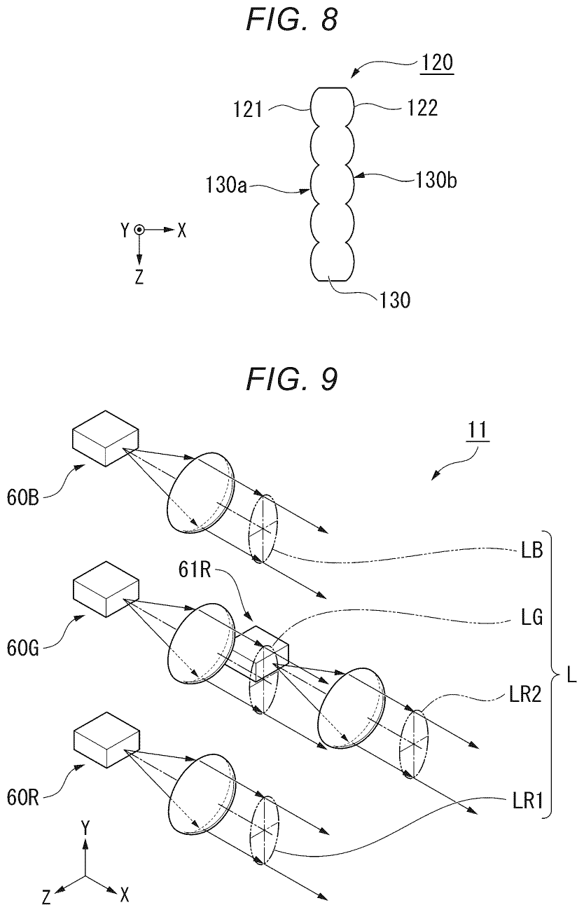

FIG. 8 is a plan view illustrating a schematic configuration of a light enlargement system 120 of the modification example as seen from the +Y side.

As illustrated in FIG. 8, the light enlargement system 120 of the modification example includes a first lenticular lens 121, a second lenticular lens 122, and a base material 130. The base material 130 is a light-transmissive substrate, the first lenticular lens 121 is provided at a first surface 130a side, and the second lenticular lens 122 is provided at a second surface 130b side opposite to the first surface 130a. That is, in the light enlargement system 120 of the modification example, the first lenticular lens 121 and the second lenticular lens 122 are integrated lenses.

In the case of the modification example, since the first lenticular lens 121 and the second lenticular lens 122 are integrated lenses, alignment of the first lenticular lens 121 and the second lenticular lens 122 is unnecessary. Therefore, according to the light source using the light enlargement system 120 of the modification example, the assembling process can be simplified.

### Second Modification Example

A second modification example of the above described embodiment will be described.

The modification example is different from the above described embodiment in the configuration of the light source section. The members in common with the above described embodiment have the same signs and the detailed description thereof will be omitted.

FIG. 9 is a perspective view illustrating a main part of a light source section 11 of the modification example.

As shown in FIG. 9, the light source section 11 of the modification example includes a blue light emitting unit 60B, a green light emitting unit 60G, a first red light emitting unit 60R, and a second red light emitting unit 61R. The light source section 11 causes the blue light emitting unit 60B, the green light emitting unit 60G, the first red light emitting unit 60R, and the second red light emitting unit 61R to emit light at different times.

The blue light emitting unit 60B has the same configuration as the blue light emitting unit 10B of the first embodiment, and emits the blue beam LB. The green light emitting unit 60G has the same configuration as the green light emitting unit 10G of the first embodiment, and emits the green beam LG. The first red light emitting unit 60R and the second red light emitting unit 61R have the same configuration as the red light emitting unit 1CR of the first embodiment, and emit red beams LR1 and LR2, respectively.

In the modification example, the blue light emitting unit 60B, the green light emitting unit 60G, and the first red light emitting unit 60R are arranged in order from the +Y side to the −Y side. The second red light emitting unit 61R is disposed side by side with the first red light emitting unit 60R in the Z-axis direction.

That is, in the modification example, an illumination light L emitted by the light source section 11 includes the blue beam LB, the green beam LG, and the red beam LR1 arranged in the Y-axis direction, and the red beam LR2 arranged in the Z-axis direction with the red beam LR1. Therefore, in the case of the modification example, the luminous flux width in the Z-axis direction of the illumination light L emitted by the light source section 11 becomes large.

In the embodiment, the red beam LR1 corresponds to an example of “first beam” of the present disclosure, the green beam LG corresponds to an example of “second beam” of the present disclosure, and the red beam LR2 corresponds to an example of “third beam” of the present disclosure.

In the modification example, the cross sections of the blue beam LB, the green beam LG, and the red beams LR1 and LR2 also have elliptical shapes as illustrated in FIG. 9. The short sides of the blue beam LB, the green beam LG, and the red beams LR1 and LR2 are along the Z-axis direction, and the long sides of the blue beam LB, the green beam LG, and the red beams LR1 and LR2 are along the Y-axis direction.

Also in the modification example, the light enlargement direction of the enlarged illumination light WL by the light enlargement system 20 coincides with the short-side direction of each of the color beams LB, LG, LR1, and LR2, and thus the light density of the enlarged illumination light WL can be suppressed to be lower.

Further, according to the light source section 11 of the modification example, the color balance of the illumination light L can be further enhanced by increasing the number of red beams LR, which are more likely to be insufficient in amount of light than the blue beam LB and the green beam LG, to two.

In the modification example, a case where the number of red beams is two is taken as an example, but the number of blue beams and the number of green beams may be increased to twos. That is, two blue light emitting sections 60B may be arranged in the Y-axis direction, or two green light emitting sections 60G may be arranged in the Y-axis direction.

The light enlargement system 20 does not affect the luminous flux width in the Z-axis direction of the enlarged illumination light WL even when the luminous flux width in the Z-axis direction of the illumination light L incident from the light source section 11 changes. Therefore, according to the light source of the present disclosure, the enlarged illumination light WL having the rectangular shape elongated in the Z-axis direction by the light enlargement system 20 regardless of the luminous flux width of the illumination light L emitted from the light source section 11.

### Second Embodiment

Hereinafter, a projector according to a second embodiment will be described.

The projector of the embodiment is different from the first embodiment in the configuration of the light enlargement system. The members in common with the above described embodiment have the same signs and the detailed description thereof will be omitted.

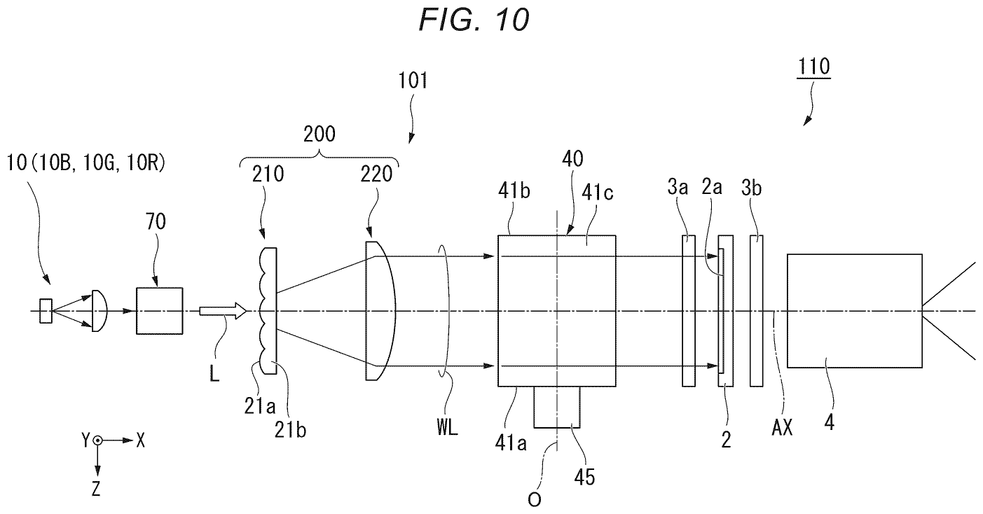

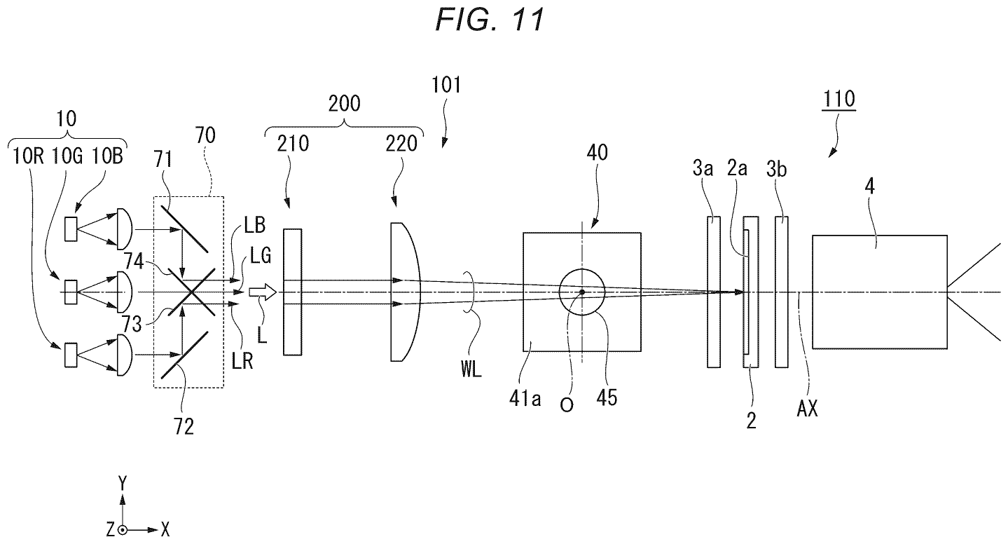

FIG. 10 is a plan view showing a schematic configuration of the projector of the embodiment as seen from the +Y side. FIG. 11 is a plan view showing a schematic configuration of the projector of the embodiment as seen from the +Z side.

As shown in FIGS. 10 and 11, a projector 110 of the embodiment includes a light source 101, a light modulation device 2, a light incident-side polarizer 3a, a light exiting-side polarizer 3b, and a projection optical device 4. The light source 101 includes a light source section 10, a luminous flux width reduction system 70, a light enlargement system 200, a superimposing system 30, and a light scanning section 40.

As illustrated in FIG. 11, the luminous flux width reduction system 70 includes a first mirror 71, a second mirror 72, a first dichroic mirror 73, and a second dichroic mirror 74. The first mirror 71 is disposed on the optical path of the blue beam LB emitted from the blue light emitting unit 10B of the light source section 10, and reflects the blue beam LB toward the illumination optical axis AX. The second mirror 72 is disposed on the optical path of the red beam LR emitted from the red light emitting unit 1CR of the light source section 10, and reflects the red beam LR toward the illumination optical axis AX.

The first dichroic mirror 73 is disposed at 450 with respect to the illumination optical axis AX, and includes a dielectric multilayer film having optical characteristics of reflecting a light in the blue wavelength band and transmitting lights in the other wavelength bands. The second dichroic mirror 74 is disposed at 45° with respect to the illumination optical axis AX and orthogonal to the first dichroic mirror 73, and includes a dielectric multilayer film having optical characteristics of reflecting a light in the red wavelength band and transmitting lights in the other wavelength bands.

The first dichroic mirror 73 is disposed to face the first mirror 71, and reflects the blue beam LB reflected by the first mirror 71 in a direction along the illumination optical axis AX. The second dichroic mirror 74 is disposed to face the second mirror 72, and reflects the red beam LR reflected by the second mirror 72 in a direction along the illumination optical axis AX. The green beam LG emitted from the green light emitting unit 10G of the light source section 10 passes through the first dichroic mirror 73 and the second dichroic mirror 74 and travels along the illumination optical axis AX.

According to the configuration, the luminous flux width reduction system 70 can reduce the luminous flux width of the illumination light L by superimposing the principal rays of the blue beam LB, the green beam LG, and the red beam LR on the illumination optical axis AX.

Also in the embodiment, the short sides of the blue beam LB, the green beam LG, and the red beam LR through the luminous flux width reduction system 70 are along the Z-axis direction.

The light enlargement system 200 of the embodiment includes a lenticular lens 210 and a parallelizing lens 220. The lenticular lens 210 has the same configuration as the first lenticular lens 21 of the first embodiment. That is, the lenticular lens 210 includes a plurality of lenses 210a including cylindrical convex lenses having positive power in the Z-axis direction and no power in the Y-axis direction. Therefore, the lenticular lens 210 diffuses and enlarges the illumination light L incident from the light source section 10 in the Z-axis direction.

The parallelizing lens 220 includes a convex lens. As shown in FIG. 10, the parallelizing lens 220 parallelizes the light emitted from the lenticular lens 210 in the Z-axis direction.

As illustrated in FIG. 11, the lenticular lens 210 transmits the illumination light L incident from the light source section 10 without changing the traveling direction in the Y-axis direction in which the lens has no power. The illumination light L transmitted through the lenticular lens 210 in the Y-axis direction is condensed on the image formation region 2a of the light modulation device 2 or the vicinity thereof by the parallelizing lens 220.

In this manner, the light enlargement system 200 of the embodiment diffuses the illumination light L emitted from the light source section 10 in the Z-axis direction to generate the enlarged illumination light WL having a rectangular shape extending in the Z-axis direction.

The rate of change (degree of diffusion) of the luminous flux width in the Z-axis direction in the light enlargement system 200 can be adjusted, for example, by adjusting optical characteristics such as a curvature and a refractive index of each lens forming the lenticular lens 210.

Also in the light enlargement system 200 of the embodiment, the enlarged illumination light WL having light density suppressed to be lower can be generated by diffusing the color beams LB, LG, and LR emitted from the light source section 10 in the Z-axis direction along the short-side direction.

In the light source 101 of the embodiment, the light enlargement direction (Z-axis direction) of the enlarged illumination light WL by the light enlargement system 200 coincides with the short-side direction of each of the color beams LB, LG, and LR incident on the light enlargement system 200. That is, the light enlargement system 20 does not diffuse the color beams LB, LG, and LR in the long-side direction, but diffuses the color beams LB, LG, and LR in the short-side direction, and thereby generating the enlarged illumination light WL. Therefore, the light density of the enlarged illumination light WL can be suppressed to be lower.

Further, since the light enlargement system 200 of the embodiment parallelizes the enlarged illumination light WL by the parallelizing lens 220 and the parallelized illumination light WL is incident on the image formation region 2a of the light modulation device 2, the superimposing system 30 and the field lens 50 can be eliminated as compared with the first embodiment.

In the light enlargement system 200 of the embodiment, the parallelizing lens 220 includes a convex lens. That is, the parallelizing lens 220 has lens power in the Y-axis direction, but the configuration of the parallelizing lens is not limited thereto. For example, the parallelizing lens may include a cylindrical convex lens having positive power in the Z-axis direction and having no power in the Y-axis direction.

Note that the technical scope of the present disclosure is not limited to the embodiments described above, and various changes can be made thereto without departing from the spirit of the present disclosure.

In addition, the specific description of the shapes, the numbers, the arrangements, the materials, and the like of the component elements of the light source and the projector are not limited to those in the embodiments described above, and can be changed as appropriate.

For example, in the embodiments and the modification examples described above, the case where the light source section 10 emits the color beams LB, LG, and LR in time sequence as the illumination light L has been described as an example, however, a monochromatic beam may be emitted from the light source section when it is applied to a projector that displays a monochromatic color.

The present disclosure will be summarized below as appendices.

### Appendix 1

A light source includes a light source section that emits a light including a first beam, a light enlargement system that generates an enlarged light by enlarging the light along a first axis, and a light scanning section that scans with the enlarged light incident from the light enlargement system in a direction along a second axis orthogonal to the first axis in an illuminated region, wherein a cross section along a plane perpendicular to a principal ray of the first beam has a shape having a long side and a short side, and the short side of the first beam at incidence on the light enlargement system is along the first axis.

According to the light source having the configuration, the light enlargement system can convert the light emitted from the light source section into the rectangular enlarged light elongated along the first axis. Further, in the case of the configuration, since the light enlargement system generates the enlarged light by diffusing the light in the short-side direction of the first beam, the light density of the enlarged light can be suppressed to be lower. Therefore, the light scanning section can illuminate the entire illuminated region while suppressing damage due to heat.

### Appendix 2

In the light source according to Appendix 1, the light emitted by the light source section further includes a second beam, the first beam and the second beam are arranged in a direction along the second axis, a cross section along a plane perpendicular to a principal ray of the second beam has a shape having a long side and a short side, and the short side of the second beam is along the first axis.

According to the configuration, even when the light source section enlarges the light including the first beam and the second beam, the light is diffused in the short-side directions of the first beam and the second beam, and thus the light density of the enlarged light can be suppressed to be lower.

### Appendix 3

The light source according to Appendix 1 or 2, further includes a superimposing system that superimposes the enlarged light emitted from the light enlargement system on the illuminated region, wherein the light enlargement system includes a first lenticular lens that divides the light into a plurality of luminous fluxes and a second lenticular lens that causes the plurality of luminous fluxes divided by the first lenticular lens to be incident on the superimposing system.

According to the configuration, by using the light enlargement system including the first lenticular lens and the second lenticular lens, the enlarged illumination light extending along the first axis can be generated and the illuminated region can be efficiently illuminated by the superimposing system.

### Appendix 4

In the light source according to Appendix 3, the first lenticular lens includes a first base material and a plurality of first lenses provided on the first base material, and the second lenticular lens includes a second base material and a plurality of second lenses provided on the second base material.

According to the configuration, since the first lenticular lens and the second lenticular lens are separately formed, the lenses can be easily manufactured.

### Appendix 5

In the light source according to Appendix 3, the light enlargement system further includes a base material on which the first lenticular lens is provided at a side of a first surface and the second lenticular lens is provided at a side of a second surface opposite to the first surface.

According to the configuration, since the first lenticular lens and the second lenticular lens are integrated lenses, alignment of the first lenticular lens and the second lenticular lens is unnecessary. Therefore, the assembly process of the light enlargement system can be simplified.

### Appendix 6

In the light source according to Appendix 1 or 2, the light enlargement system includes a lenticular lens that enlarges the light along the second axis and a parallelizing lens that parallelizes the light emitted from the lenticular lens in a direction along the second axis.

According to the configuration, the enlarged illumination light extending along the first axis can be generated by using the light enlargement system including the lenticular lens and the parallelizing lens.

### Appendix 7

The light source according to any one of Appendices 1 to 6, further includes a field lens that deflects a light incident from the light scanning section.

According to the configuration, the light scanning section can efficiently illuminate the illuminated region with the enlarged light.

### Appendix 8

In the light source according to Appendix 2, the light emitted by the light source section further includes a third beam arranged with the first beam or the second beam in a direction along the first axis, a cross section along a plane perpendicular to a principal ray of the third beam has a shape having a long side and a short side, and the short side of the third beam is along the first axis.

According to the configuration, even when the light source section emits a light including three beams arranged in two directions of the first axis and the second axis, the light density of the enlarged light can be suppressed to be lower by diffusing the light in the short-side directions of the first beam, the second beam, and the third beam.

### Appendix 9

In the light source according to appendix 8, the first beam, the second beam, and the third beam are color beams different from one another, and the light source section emits the first beam, the second beam, and the third beam in time sequence.

According to the configuration, the color of the light emitted from the light source can be changed in time sequence.

### Appendix 10

In the light source according to any one of Appendices 1 to 9, an aspect ratio of the cross section of the first beam is three times or more.

According to the configuration, the effect of suppressing the light density of the enlarged light can be further enhanced by using the light source section that emits the light including the first beam having the aspect ratio at three times or more.

### Appendix 11

In the light source according to any one of Appendices 1 to 10, a long-side direction of an aspect ratio of a cross section of the light emitted from the light source section is a direction along the second axis, and a long-side direction of an aspect ratio of a cross section of the enlarged light emitted from the light enlargement system is a direction along the first axis.

According to the configuration, the light having the long side in the second axis direction can be enlarged in the first axis direction, and thus an enlarged light having a long side in the first axis direction can be favorably generated.

### Appendix 12

A projector includes the light source according to any one of Appendices 1 to 11, a light modulation device that modulates a light incident from the light source, and a projection optical device that projects the light modulated by the light modulation device.

According to the projector having the configuration, since the enlarged light emitted from the light source scans the image formation region of the light modulation device, a brighter image can be projected. Further, since the light density of the enlarged light is suppressed, the damage due to heat in the light modulation device is suppressed, and thus the reliability of the projector can be further enhanced.

### Appendix 13

A projector includes the light source according to any one of Appendices 3 to 5, a light modulation device that modulates a light incident from the light source according to image information, and a projection optical device that projects the light modulated by the light modulation device, wherein the light modulation device has an image formation region for generation of an image light, and a dimension S in a direction along an enlargement direction of the enlarged light in the image formation region satisfies a relationship of S<(a×b1/b)−1.0, a being a lens pitch of the first lenticular lens and the second lenticular lens, b being a lens-to-lens distance between the first lenticular lens and the second lenticular lens, and b1 being a distance between the superimposing system and the light modulation device.

According to the configuration, the light of the light source can effectively illuminate the image formation region of the light modulation device even when the attachment of the optical components varies or the precision of the lenticular lens is poor.

### Appendix 14

A projector includes the light source according to any one of Appendices 3 to 5, a light modulation device that modulates a light incident from the light source according to image information, and a projection optical device that projects the light modulated by the light modulation device, wherein the light modulation device has an image formation region, the light source section of the light source includes a light emitting element that emits the first beam and a collimator lens that collimates the first beam emitted from the light emitting element, and a dimension S1 of the image formation region in a direction along the first axis satisfies a relationship of S1>2×c×d1/d, c being a dimension in the direction along the first axis in a light emitting region of the light emitting element, d being a focal length of the collimator lens, and d1 being a distance between the superimposing system and the light modulation device.

According to the configuration, the light of the light source can be efficiently incident on the image formation region with suppressed heat generation in the image formation region.

What is claimed is:

1. A light source comprising:
a light source section that emits a light including a first beam;
a light enlargement system that generates an enlarged light by enlarging the light along a first axis; and
a light scanning section that scans with the enlarged light incident from the light enlargement system in a direction along a second axis orthogonal to the first axis in an illuminated region, wherein
a cross section along a plane perpendicular to a principal ray of the first beam has a shape having a long side and a short side, and
the short side of the first beam at incidence on the light enlargement system is along the first axis.

2. The light source according to claim 1, wherein
the light emitted by the light source section further includes a second beam,
the first beam and the second beam are arranged in a direction along the second axis,
a cross section along a plane perpendicular to a principal ray of the second beam has a shape having a long side and a short side, and
the short side of the second beam is along the first axis.

3. The light source according to claim 1, further comprising a superimposing system that superimposes the enlarged light emitted from the light enlargement system on the illuminated region, wherein
the light enlargement system includes a first lenticular lens that divides the light into a plurality of luminous fluxes and a second lenticular lens that causes the plurality of luminous fluxes divided by the first lenticular lens to be incident on the superimposing system.

4. The light source according to claim 3, wherein
the first lenticular lens includes a first base material and a plurality of first lenses provided on the first base material, and
the second lenticular lens includes a second base material and a plurality of second lenses provided on the second base material.

5. The light source according to claim 3, wherein
the light enlargement system further includes a base material on which the first lenticular lens is provided at a side of a first surface and the second lenticular lens is provided at a side of a second surface opposite to the first surface.

6. The light source according to claim 1, wherein
the light enlargement system includes a lenticular lens that enlarges the light along the second axis and a parallelizing lens that parallelizes the light emitted from the lenticular lens in a direction along the second axis.

7. The light source according to claim 1, further comprising a field lens that deflects a light incident from the light scanning section.

8. The light source according to claim 2, wherein
the light emitted by the light source section further includes a third beam arranged with the first beam or the second beam in a direction along the first axis,
a cross section along a plane perpendicular to a principal ray of the third beam has a shape having a long side and a short side, and
the short side of the third beam is along the first axis.

9. The light source according to claim 8, wherein
the first beam, the second beam, and the third beam are color beams different from one another, and
the light source section emits the first beam, the second beam, and the third beam in time sequence.

10. The light source according to claim 1, wherein
an aspect ratio of the cross section of the first beam is three times or more.

11. The light source according to claim 1, wherein
a long-side direction of an aspect ratio of a cross section of the light emitted from the light source section is a direction along the second axis, and
a long-side direction of an aspect ratio of a cross section of the enlarged light emitted from the light enlargement system is a direction along the first axis.

12. A projector comprising:
the light source according to claim 1;
a light modulation device that modulates a light incident from the light source; and
a projection optical device that projects the light modulated by the light modulation device.

13. A projector comprising:
the light source according to claim 3;
a light modulation device that modulates a light incident from the light source according to image information; and
a projection optical device that projects the light modulated by the light modulation device, wherein
the light modulation device has an image formation region for generation of an image light, and
a dimension S in a direction along an enlargement direction of the enlarged light in the image formation region satisfies a relationship of S<(a×b1/b)−1.0, a being a lens pitch of the first lenticular lens and the second lenticular lens, b being a lens-to-lens distance between the first lenticular lens and the second lenticular lens, and b1 being a distance between the superimposing system and the light modulation device.

14. A projector comprising:
the light source according to claim 3;
a light modulation device that modulates a light incident from the light source according to image information; and
a projection optical device that projects the light modulated by the light modulation device, wherein
the light modulation device has an image formation region,
the light source section of the light source includes a light emitting element that emits the first beam and a collimator lens that collimates the first beam emitted from the light emitting element, and
a dimension S1 of the image formation region in a direction along the first axis satisfies a relationship of S1>2×c×d1/d, c being a dimension in the direction along the first axis in a light emitting region of the light emitting element, d being a focal length of the collimator lens, and d1 being a distance between the superimposing system and the light modulation device.
